(19) United States
(12) Patent Application Publication
(10) Pub. No.: US 2020/0209434 A1
(43) Pub. Date: Jul. 2, 2020

(54) OPTICAL ELEMENT AND PROJECTION LENS

(71) Applicant: Konica Minolta, Inc., Tokyo (JP)

(72) Inventors: Yoshihiro NAKANO, Tondabaya-shi, Osaka (JP); Koji TAKAHARA, Hirakata-shi, Osaka (JP); Miyuki TERAMOTO, Osakasayama-shi, Osaka (JP)

(73) Assignee: Konica Minolta, Inc., Tokyo (JP)

(21) Appl. No.: 16/615,572

(22) PCT Filed: Mar. 9, 2018
(86) PCT No.: PCT/JP2018/009123

§ 371 Date: Nov. 21, 2019

(30) Foreign Application Priority Data
May 26, 2017 (JP) 2017-104237

(51) Int. Cl. G02B 1/115; G02B 13/16; G02B 15/20

(52) U.S. Cl. CPC G02B 1/115; G02B 15/20; G02B 13/16

(57) ABSTRACT

An optical element includes: an optical element substrate; and an antireflective film on the optical element substrate. The antireflective film has a structure in which, in order from an air side of the anti-reflection film, a SiO₂ low-refractive index film and one or more TiO₂, Nb₂O₅, or Ta₂O₅ high-refractive index films are alternately stacked in eight or more layers.

### TECHNICAL FIELD

The present invention relates to an optical element and a projection lens, and more specifically to an optical element including an antireflective film, and a projector-grade projection lens including the same.

### BACKGROUND

With advancement of high precision of projector-grade projection lenses, as a lens material for a projection lens, optical glass with lower dispersion or higher dispersion at various refractive indices has been used. However, some products provided by optical glass manufacturers have increased light absorption loss within the glass when heated by a conventional antireflective film manufacturing method. For example, in the case of optical glass, e.g., FD225 provided by HOYA Corporation or S-NPH1W provided by OHARA Inc., when coating is applied by heating at 300° C., which is a conventional manufacturing method, light absorption loss increases by about 1.5% at wavelength of 430 nm. Therefore, when a large amount of light of 10,000 lumens or more passes the optical glass, heat is generated even with a small absorption rate, and a change in refractive index of the optical glass resulting therefrom affects the projection performance.

In order to prevent an increase in light absorption loss within a glass substrate, it is necessary to perform coating under a low-temperature condition. Therefore, MgF₂, which has often been used, cannot be used in terms of reliability, e.g., strength. Accordingly, an antireflective film that does not use MgF₂ is necessary. Examples of the antireflective film not using MgF₂ include an antireflective film described in Patent Literature 1. The antireflective film described in Patent Literature 1 includes 13 alternating layers including a high-refractive index film, e.g., of Nb₂O₅ or the like, and a low-refractive index film, e.g., of SiO₂, and reflectivity in visible light wavelength band is suppressed to 0.3% or less.

### PATENT LITERATURE

Patent Literature 1: JP 2010-217445 A

However, an optical element including the antireflective film described in Patent Literature 1 has low antireflective performance despite a large number of film layers, and, moreover, cannot obtain antireflective performance stable across the entire visible light wavelength band.

### SUMMARY

One or more embodiments of the present invention provide an optical element that has high antireflective performance even with a small number of film layers, and has an antireflective film with antireflective performance stable over an entire visible light wavelength band and small light absorption loss within an optical element substrate, and a projection lens including the same.

In one or more embodiments, an optical element comprises an antireflective film on an optical element substrate, wherein the antireflective film has a structure in which, in order from an air side, a low-refractive index film formed of SiO₂ and one or more types of high-refractive index film formed of TiO₂, Nb₂O₅, or Ta₂O₅ are alternately stacked in eight or more layers, and when a design dominant wavelength (predetermined wavelength) is 550 nm in the antireflective film, quarter wave optical thicknesses from a first layer to a sixth layer from the air side are as follows:

0.94±0.05 in a low-refractive index film of the first layer;

1.29±0.25 in a high-refractive index film of the second layer;

0.08±0.05 in a low-refractive index film of the third layer;

0.45±0.20 in a high-refractive index film of the fourth layer;

2.05±0.20 in a low-refractive index film of the fifth layer; and

0.45±0.20 in a high-refractive index film of the sixth layer.

The projector-grade projection lens according to one or more embodiments of the present invention is characterized by including the optical element according to one or more embodiments of the present invention as a lens element.

According to one or more embodiments, because an antireflective film stacked in eight or more layers has a characteristic film configuration from the first layer to the sixth layer, high antireflective performance can be obtained even with a small number of film layers, and antireflective performance stable over an entire visible light wavelength band can be obtained. For example, antireflective performance having reflectivity of 0.2% or less can be achieved with an antireflective film including ten layers. Moreover, because the antireflective film is formed of a material that can be applied under a low-temperature condition, the light absorption loss within the optical element substrate can be reduced, and an optical element substrate having various refractive indices can be used, thereby providing high versatility. Accordingly, it is possible to achieve an optical element that has high antireflective performance even with a small number of film layers, and has an antireflective film with antireflective performance stable over an entire visible light wavelength band and small light absorption loss within an optical element substrate, and a projection lens including the same.

### BRIEF DESCRIPTION OF DRAWINGS

FIG. 1 is a cross-sectional view schematically illustrating one or more embodiments of an optical element including an antireflective film.

FIG. 2 is an optical configuration diagram illustrating one or more embodiments of a projection lens including the optical element of FIG. 1 as a lens element.

FIG. 3 is a graph illustrating an antireflective characteristic of Example 1 by spectral reflectivity according to one or more embodiments.

FIG. 4 is a graph illustrating an antireflective characteristic of Example 2 by spectral reflectivity according to one or more embodiments.

FIG. 5 is a graph illustrating an antireflective characteristic of Example 3 by spectral reflectivity according to one or more embodiments.

FIG. 6 is a graph illustrating an antireflective characteristic of Example 4 by spectral reflectivity according to one or more embodiments.

FIG. 7 is a graph illustrating an antireflective characteristic of Example 5 by spectral reflectivity according to one or more embodiments.

FIG. 8 is a graph illustrating an antireflective characteristic of Example 6 by spectral reflectivity according to one or more embodiments.

FIG. 9 is a graph illustrating an antireflective characteristic of Example 7 by spectral reflectivity according to one or more embodiments.

FIG. 10 is a graph illustrating an antireflective characteristic of Comparative Example 1 by spectral reflectivity.

FIG. 11 is a graph illustrating an antireflective characteristic of Comparative Example 2 by spectral reflectivity.

FIG. 12 is a graph illustrating spectral characteristics of Example 6 according to one or more embodiments and Comparative Example 2 by amount of increase in light absorption loss.

### DETAILED DESCRIPTION

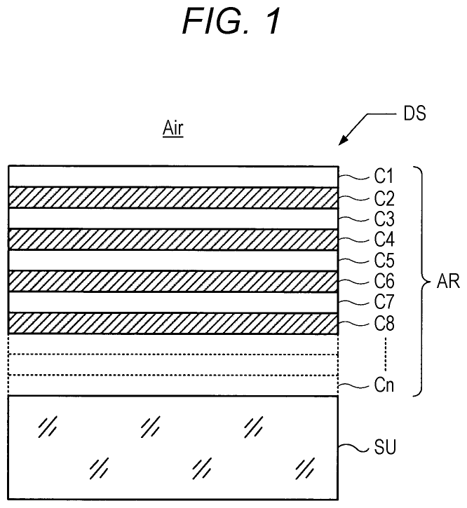

An optical element, a projection lens, and the like according to one or more embodiments of the present invention are described below with reference to the drawings. FIG. 1 schematically illustrates, with respect to one or more embodiments of an optical element including an antireflective film, a stack structure of an antireflective film AR in optical cross-section.

An optical element DS illustrated in FIG. 1 includes the antireflective film AR on an optical element substrate SU, and the antireflective film AR has a structure in which, in order from air (Air) side, a low-refractive index film formed of SiO₂ and one or more types of high-refractive index film formed of TiO₂, Nb₂O₅, or Ta₂O₅ are alternately stacked in eight or more layers. When i-th (i=1, 2, 3, . . . , n) layer from the air side is an i-th layer Ci, an odd number-th layer, e.g., a first layer C1, a third layer C3, a fifth layer C5, or a seventh layer C7, is the low-refractive index film formed of SiO₂, and an even number-th layer, e.g., a second layer C2, a fourth layer C4, a sixth layer C6, or an eighth layer C8, is the high-refractive index film formed of TiO₂, Nb₂O₅, or Ta₂O₅. Accordingly, in the films included in the single antireflective film AR, the number of types of the low-refractive index film is one, but the number of types of the high-refractive index film may be two or three.

In the antireflective film AR, when design dominant wavelength λ₀ is 550 nm, from the air side, the quarter wave optical thickness (QWOT: Quarter Wave Optical Thickness) from the first layer C1 to the sixth layer C6 is as follows:

0.94±0.05 in the low-refractive index film of the first layer C1;

1.29±0.25 in the high-refractive index film of the second layer C2;

0.08±0.05 in the low-refractive index film of the third layer C3;

0.45±0.20 in the high-refractive index film of the fourth layer C4;

2.05±0.20 in the low-refractive index film of the fifth layer C5; and

0.45±0.20 in the high-refractive index film of the sixth layer C6. Note that the quarter wave optical thickness is expressed by Formula: QWOT=4·n·d/λ₀ (where, d: physical film thickness, n: refractive index, and λ₀: design dominant wavelength).

Examples of a material forming the optical element substrate SU include a glass substrate having refractive index nd of 1.80809±0.001 with respect to d line (the D-line of sodium) and Abbe number vd of 22.76±0.36. Some of such glass substrate has increased light absorption loss due to heating during film formation as described above. That is, with the optical element substrate SU assumed here, when coated with the antireflective film AR while being left for one hour or more at 300° C. or higher, the light absorption loss increases by 1% or more at wavelength of 430 nm. In order to prevent an increase in absorption loss, it is necessary to perform film formation at low temperatures. Thus, in one or more embodiments, the antireflective film AR is configured to satisfy the aforementioned conditions in order to perform film formation at low temperatures.

With the aforementioned configuration, because the antireflective film AR having a stack of eight or more layers has a characteristic film configuration from the first layer C1 to the sixth layer C6, high antireflective performance can be obtained even with a small number of film layers, and antireflective performance stable over an entire visible light wavelength band can be obtained. For example, antireflective performance having reflectivity of 0.2% or less can be achieved with the antireflective film AR including ten layers. Moreover, because the antireflective film AR is formed of a material that can be applied under a low-temperature condition, the light absorption loss within the optical element substrate SU can be reduced, and the optical element substrate SU having various refractive indices can be used, thereby providing high versatility. Accordingly, it is possible to achieve the optical element DS that has high antireflective performance even with a small number of film layers, and has the antireflective film AR with antireflective performance stable over an entire visible light wavelength band and small light absorption loss within the optical element substrate SU.

The film thicknesses of the seventh layer C7 and the subsequent layers can easily be obtained through optimization calculation using optical thin film design software or the like when the layers up to the sixth layer C6 of the antireflective film AR are limited by the aforementioned condition. Then, with the film configuration of the seventh layer C7 and the subsequent layers, the aforementioned effect can be obtained with a good balance, and improved antireflective performance or the like can be obtained.

For example, in one or more embodiments of an antireflective film AR in which a total number of film layers is ten, when design dominant wavelength λ₀ is 550 nm, the quarter wave optical thickness from the seventh layer C7 to the tenth layer C10 from the air side may be as follows:

0.19±0.10 in the low-refractive index film of the seventh layer C7;

1.03±0.35 in the high-refractive index film of the eighth layer C8;

0.24±0.15 in the low-refractive index film of the ninth layer C9; and

0.30±0.10 in the high-refractive index film of the tenth layer C10, and maximum reflectivity at wavelength of 420 to 680 nm be 0.2% or less.

For example, in the case of an antireflective film AR in which a total number of film layers is thirteen, when design dominant wavelength λ₀ is 550 nm, the quarter wave optical thickness from the seventh layer C7 to the thirteenth layer C13 from the air side be as follows:

0.11±0.10 in the low-refractive index film of the seventh layer C7;

1.32±0.10 in the high-refractive index film of the eighth layer C8;

0.42±0.10 in the low-refractive index film of the ninth layer C9;

0.31±0.10 in the high-refractive index film of the tenth layer C10;

1.05±0.35 in the low-refractive index film of the eleventh layer C11;

0.21±0.15 in the high-refractive index film of the twelfth layer C12; and

0.38±0.10 in the low-refractive index film of the thirteenth layer C13, and

maximum reflectivity at wavelength of 420 to 780 nm be 0.4% or less.

In one or more embodiments, each layer of the antireflective film AR may be formed by a vacuum deposition method under heating at, for example, 150° C. or less, or may be formed by a vacuum deposition method using ion assist. The use of ion assisted deposition enables a reduction in change in film density, roughness of the film surface, or the like of the antireflective film AR resulting from a variation in degree of vacuum of the vacuum deposition method or the like. Thus, it is possible to suppress occurrence of color unevenness or deterioration of characteristic reproducibility resulting from a change in film density (i.e., a change in refractive index of the film). Moreover, using the ion assisted deposition to form the antireflective film AR enables the use of a high-refractive index material which was relatively difficult to use for a layer that forms the antireflective film AR.

For example, with a projector-grade projection lens, because a large amount of light passes through a lens element forming the projector-grade projection lens, heat is generated even when the light absorption loss within the lens element is small. When the refractive index of the lens element is changed due to the heat generation, there is a possibility that the optical performance of the projection lens is reduced. Thus, when the antireflective film AR having the aforementioned configuration is provided on the lens substrate, which is the optical element substrate SU, the lens element that has small light absorption loss within the lens substrate and that has improved antireflective performance can be obtained. Then, when the lens element including such antireflective film AR is used for a projection lens, high optical performance and antireflection effect can be obtained stably and reliably, enabling a projector including the lens element to have high image quality. One or more embodiments of the projector-grade projection lens to which the optical element DS, which is a lens element, including the antireflective film AR has been applied is described below.

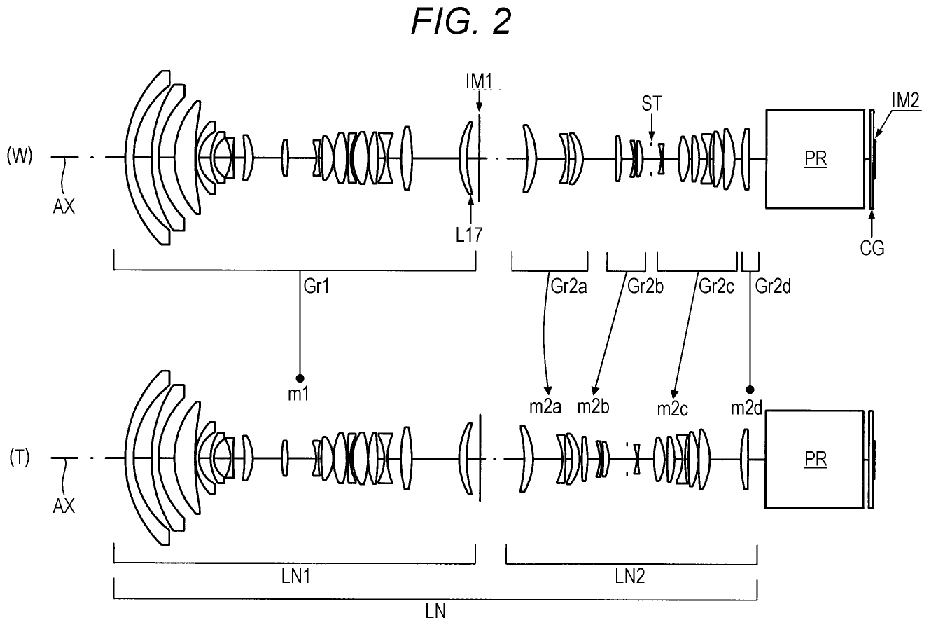

FIG. 2 is an optical configuration diagram of a projector-grade projection lens LN according to one or more embodiments, illustrating the lens cross-sectional shape, the lens arrangement, or the like of the projection lens LN, which is a zoom lens, with respect to a wide angle end (W) and a telephoto end (T), in optical cross-section. Note that a prism PR (e.g., TIR (Total Internal Reflection) prism, color separation synthesis prism) and cover glass CG of an image display element are arranged on the reduction side of the projection lens LN.

It is configured such that the projection lens LN includes, in order from the magnifying side, a first optical system LN1 (from a first surface to a portion in front of an intermediate image surface IM1) and a second optical system LN2 (from a portion behind the intermediate image surface IM1 to a last lens surface), and a second optical system LN2 forms the intermediate image IM1 of an image (reduction-side image surface) displayed on an image display surface IM2 of an image display element, and the intermediate image IM1 magnifies and project the first optical system LN1. Note that an aperture stop ST is positioned near the middle of the second optical system LN2 (the most magnifying side of the second c-lens group Gr2c).

The projection lens LN is an aspherical surface-free spherical lens system formed of 30 lens components in total in which 17 on the magnifying side is the first optical system LN1 that magnifies and projects the intermediate image IM1 and 13 on the reduction side is the second optical system LN2 that forms the intermediate image IM1. The first optical system LN1 generally includes a positive first lens group Gr1, and the second optical system LN2 includes, in order from the magnifying side, a positive second a-lens group Gr2a, a positive second b-lens group Gr2b, a positive second c-lens group Gr2c, and a positive second d-lens group Gr2d. The position of the intermediate image IM1 during zooming is fixed, and magnification is performed only with the second optical system LN2 (five positive group zoom configuration).

Arrows m1, m2a, m2b, m2c, and m2d in FIG. 2 schematically indicate movement or fixation of the first lens group Gr1 and the second a- to second d-lens group Gr2a to Gr2d during zooming from the wide angle end (W) to the telephoto end (T). That is, it is configured such that the first lens group Gr1 and the second d-lens group Gr2d are fixation groups and the second a- to second c-lens group Gr2a to Gr2c are movement groups, and the second a- to second c-lens group Gr2a to Gr2c are moved along optical axis AX to perform zooming. Regarding the magnification from the wide angle end (W) to the telephoto end (T), the second a-lens group Gr2a moves on a locus protruding on the magnifying side (U turn movement), and the second b-lens group Gr2b and the second c-lens group Gr2c are monotonically moved to the magnifying side.

The projection lens LN is configured to perform magnification (i.e., zooming) from the wide angle end (W) to the telephoto end (T) in such a way that the movement groups are relatively moved with respect to the image display surface IM2 as described above to change the intervals of the groups on the axis. Because the zoom positions of the first lens group Gr1 and the second d-lens group Gr2d are fixed, the entire length of the optical system is not changed by the magnification and the movement components are reduced such that the magnification mechanism can be simplified. Note that the zoom positions of the prism PR and the cover glass CG positioned on the reduction side of the second d-lens group Gr2d are also fixed.

The intermediate image IM1 formed by the second optical system LN2 is present near the middle of the entire projection lens LN and is an image magnifying the image display surface IM2. In this way, an off-axis light beam passage position of the lens near the intermediate image IM1 can be high, and the high optical performance can be achieved without use of an aspherical surface. A 17th lens element L17 from the magnifying side that is adjacently arranged on the magnifying side of the intermediate image IM1 is a positive lens having a meniscus shape, which is recessed on the intermediate image IM1 side, and at least one side thereof includes the aforementioned antireflective film AR (FIG. 1). Moreover, a substrate material of the lens element L17 is assumed to be those that have refractive index nd of 1.80809±0.001 with respect to d line and Abbe number vd of 22.76±0.36, and, when coated with the antireflective film AR while being left for one hour or more at 300° C. or higher, light absorption loss increased by 1% or more at wavelength of 430 nm.

In the projection lens LN having a large angle of view, when a lens diameter is reduced as illustrated in FIG. 2, off-axis aberration, e.g., curvature of field or chromatic aberration of magnification, tends to occur. However, when a substrate material having high refractive index and large anomalous dispersibility is employed as described above for the lens element L17 positioned immediately in front of the intermediate image IM1 having high off-axis light beam passage position, it is possible to efficiently correct the curvature of field and the chromatic aberration of magnification. Moreover, because the antireflective film AR of the lens element L17 is formed of a material that can be applied under a low-temperature condition, an increase in light absorption loss within the lens element L17 can be prevented and improved antireflective performance can be obtained.

As can be seen from the above description, the aforementioned embodiments or examples described below have characterizing configurations (#1) to (#6) or the like described below.

(#1): An optical element comprising an antireflective film on an optical element substrate, wherein

the antireflective film has a structure in which, in order from an air side, a low-refractive index film formed of SiO₂ and one or more types of high-refractive index film formed of TiO₂, Nb₂O₅, or Ta₂O₅ are alternately stacked in eight or more layers, and

when a design dominant wavelength is 550 nm in the antireflective film, quarter wave optical thicknesses from a first layer to a sixth layer from the air side are as follows:

0.94±0.05 in a low-refractive index film of the first layer;

1.29±0.25 in a high-refractive index film of the second layer;

0.08±0.05 in a low-refractive index film of the third layer;

0.45±0.20 in a high-refractive index film of the fourth layer;

2.05±0.20 in a low-refractive index film of the fifth layer; and

0.45±0.20 in a high-refractive index film of the sixth layer.

(#2): The optical element according to (#1), wherein a total number of film layers of the antireflective film is ten, when a design dominant wavelength is 550 nm in the antireflective film, quarter wave optical thicknesses from a seventh layer to a tenth layer from the air side are as follows:

0.19±0.10 in a low-refractive index film of the seventh layer;

1.03±0.35 in a high-refractive index film of the eighth layer;

0.24±0.15 in a low-refractive index film of the ninth layer; and

0.30±0.10 in a high-refractive index film of the tenth layer, and

maximum reflectivity at wavelength of 420 to 680 nm is 0.2% or less.

(#3): The optical element according to (#1), wherein a total number of film layers of the antireflective film is thirteen,

when a design dominant wavelength is 550 nm in the antireflective film, quarter wave optical thicknesses of a seventh layer to a thirteenth layer from the air side are as follows:

0.11±0.10 in a low-refractive index film of the seventh layer;

1.32±0.10 in a high-refractive index film of the eighth layer;

0.42±0.10 in a low-refractive index film of the ninth layer;

0.31±0.10 in a high-refractive index film of the tenth layer;

1.05±0.35 in a low-refractive index film of the eleventh layer;

0.21±0.15 in a high-refractive index film of the twelfth layer; and

0.38±0.10 in a low-refractive index film of the thirteenth layer, and

maximum reflectivity at wavelength of 420 to 780 nm is 0.4% or less.

(#4): The optical element according to any one of (#1) to (#3), wherein when the optical element substrate is coated with the antireflective film while being left for one hour or more at 300° C. or higher, light absorption loss increases by 1% or more at wavelength of 430 nm.

(#5): The optical element according to any one of (#1) to (#4), wherein in the optical element substrate, refractive index with respect to d line is 1.80809±0.001, and Abbe number is 22.76±0.36.

(#6): A projector-grade projection lens comprising the optical element according to any one of (#1) to (#5) as a lens element.

### EXAMPLES

One or more embodiments of the optical element to which the present invention has been applied is more specifically described below in conjunction with Examples 1 to 7 and Comparative Examples 1 and 2.

Tables 1 to 9 indicate configurations of Examples 1 to 7 and Comparative Examples 1 and 2 of the optical element DS. In Tables 1 to 9, regarding layers Ci (i=1, 2, 3, . . . , n) forming the antireflective film AR, film formation materials, quarter wave optical thicknesses (QWOT), and refractive indices nd with respect to d line (wavelength 587.6 nm) are indicated, and, regarding optical element substrate SU made of glass, refractive indices nd and Abbe numbers vd are indicated. Note that the quarter wave optical thickness is represented by Formula: QWOT=4·n·d/λ₀ (where, d: physical film thickness, n: refractive index, λ₀: design dominant wavelength), and the Abbe number is expressed by Formula: vd=(nd−1)/(nF−nC) (where, ng, nd, nF, nC: refractive indices with respect to g line, d line, F line, C line).

The refractive indices nd of the film formation materials of Examples 1 to 7 and Comparative Examples 1 and 2 are as follows: 1.44 to 1.48 with SiO₂, 2.2 to 2.3 with Ta₂O₅, 2.3 to 2.4 with Nb₂O₅, 2.4 to 2.5 with TiO₂, 1.38 to 1.386 with MgF₂, 1.58 to 1.65 with Al₂O₃, and 2.0 to 2.1 with LaTiO₃.

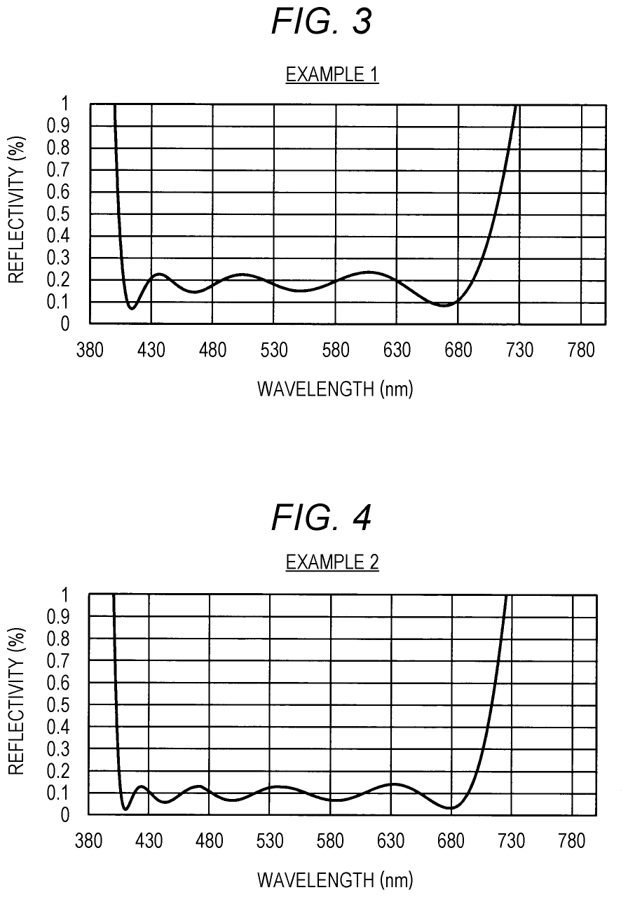

The graphs of FIGS. 3 to 11 illustrate spectral reflectivity characteristics of Examples 1 to 7 according to one or more embodiments and Comparative Examples 1 and 2. In FIGS. 3 to 11, a vertical axis is reflectivity (%), and a horizontal axis is wavelength (nm).

In Example 1, as indicated in Table 1, an antireflective film AR on an optical element substrate SU (nd=1.81) is configured to include eight layer films of Ta₂O₅ and SiO₂. The antireflective film AR was formed using ion assist in a vacuum deposition method under heating at 150° C. or less. Moreover, as illustrated in FIG. 3, maximum reflectivity at wavelength of 420 to 680 nm is 0.3% or less, and average reflectivity is 0.18%.

In Example 2, as indicated in Table 2, an antireflective film AR on an optical element substrate SU (nd=1.70) is configured to include ten layer films of TiO₂ and SiO₂. The antireflective film AR was formed using ion assist in a vacuum deposition method under heating at 150° C. or less. Moreover, as illustrated in FIG. 4, maximum reflectivity at wavelength of 420 to 680 nm is 0.2% or less, and average reflectivity is 0.10%.

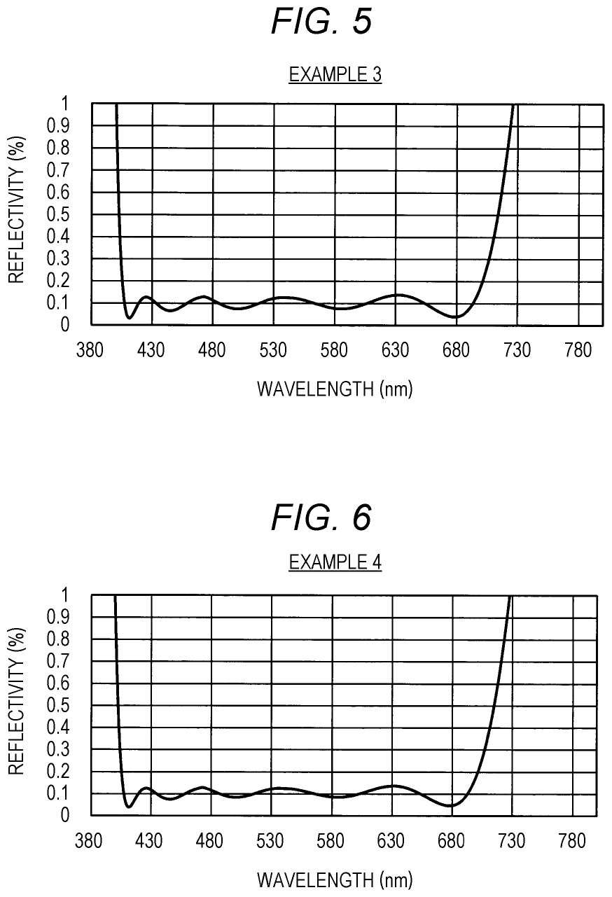

In Example 3, as indicated in Table 3, an antireflective film AR on an optical element substrate SU (nd=1.81) is configured to include ten layer films of TiO₂ and SiO₂. The antireflective film AR was formed using ion assist in a vacuum deposition method under heating at 150° C. or less. Moreover, as illustrated in FIG. 5, maximum reflectivity at wavelength of 420 to 680 nm is 0.2% or less, and average reflectivity is 0.10%.

In Example 4, as indicated in Table 4, an antireflective film AR on an optical element substrate SU (nd=1.90) is configured to include ten layer films of TiO₂ and SiO₂. The antireflective film AR was formed using ion assist in a vacuum deposition method under heating at 150° C. or less. Moreover, as illustrated in FIG. 6, maximum reflectivity at wavelength of 420 to 680 nm is 0.2% or less, and average reflectivity is 0.10%.

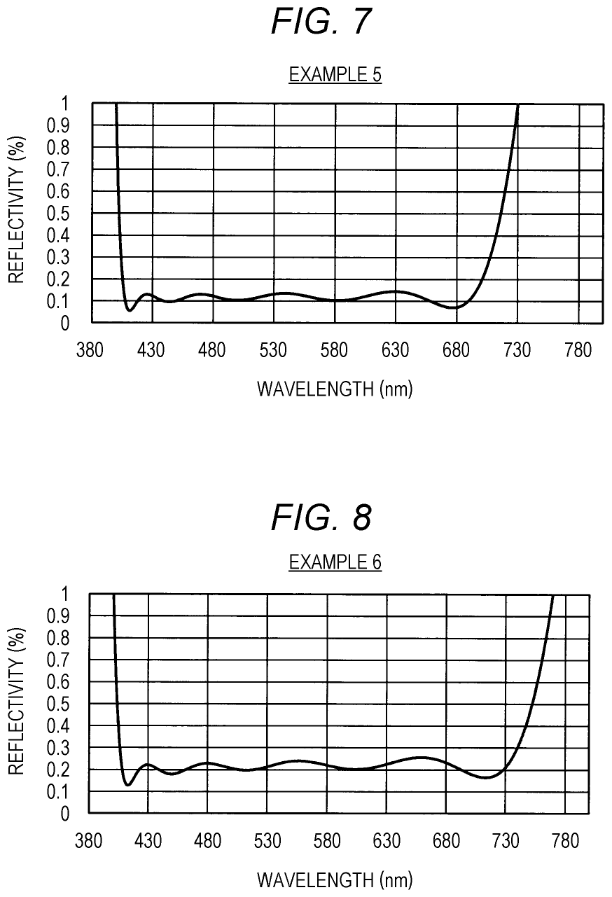

In Example 5, as indicated in Table 5, an antireflective film AR on an optical element substrate SU (nd=1.81) is configured to include ten layer films of Nb₂O₅ and SiO₂. The antireflective film AR was formed using ion assist in a vacuum deposition method under heating at 150° C. or less. Moreover, as illustrated in FIG. 7, maximum reflectivity at wavelength of 420 to 680 nm is 0.2% or less, and average reflectivity is 0.12%.

In Example 6, as indicated in Table 6, an antireflective film AR on an optical element substrate SU (nd=1.81) is configured to include ten layer films of Ta₂O₅ and SiO₂. The antireflective film AR was formed using ion assist in a vacuum deposition method under heating at 150° C. or less. Moreover, as illustrated in FIG. 8, maximum reflectivity at wavelength of 420 to 730 nm is 0.3% or less, and average reflectivity is 0.22%.

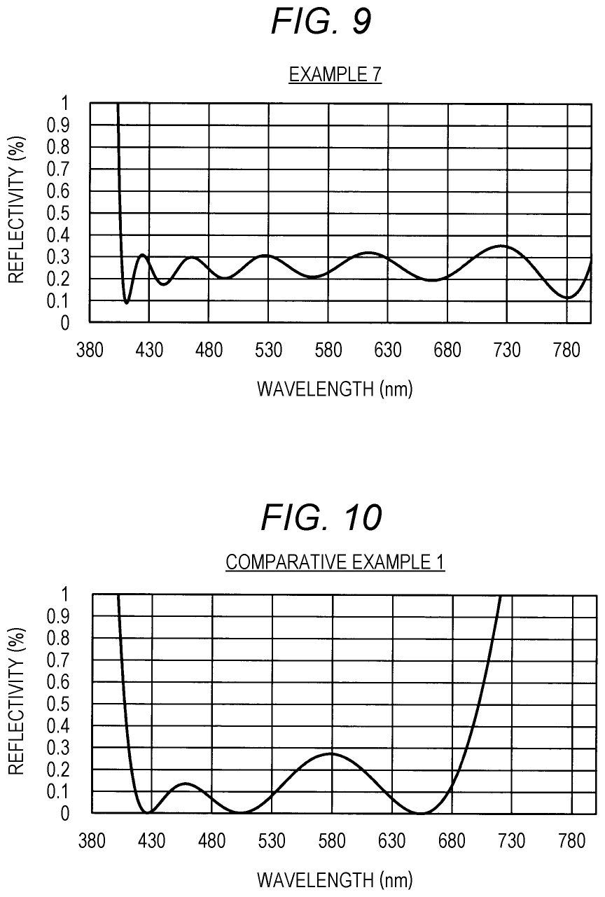

In Example 7, as indicated in Table 7, an antireflective film AR on an optical element substrate SU (nd=1.81) is configured to include thirteen layer films of Ta₂O₅ and SiO₂. The antireflective film AR was formed using ion assist in a vacuum deposition method under heating at 150° C. or less. Moreover, as illustrated in FIG. 9, maximum reflectivity at wavelength of 420 to 780 nm is 0.4% or less, and average reflectivity is 0.26%.

In Comparative Example 1, as indicated in Table 8, an antireflective film AR on an optical element substrate SU (nd=1.81) is configured to include general four layer films using MgF₂. The antireflective film AR was formed by a vacuum deposition method under heating at 300° C. Moreover, as illustrated in FIG. 10, maximum reflectivity at wavelength of 420 to 680 nm is 0.3% or less, and average reflectivity is 0.11%.

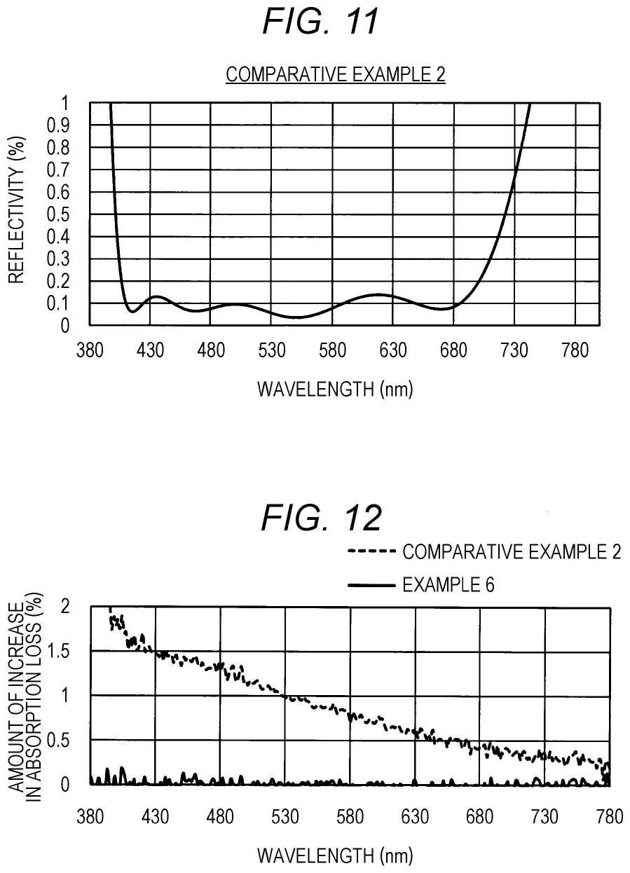

In Comparative Example 2, as indicated in Table 9, an antireflective film AR on an optical element substrate SU (nd=1.81) is configured to include general six layer films using MgF₂. The antireflective film AR was formed by a vacuum deposition method under heating at 300° C. Moreover, as illustrated in FIG. 11, maximum reflectivity at wavelength of 420 to 680 nm is 0.2% or less, and average reflectivity is 0.09%.

The graph of FIG. 12 illustrates spectral characteristics of Example 6 and Comparative Example 2 by amount of increase in light absorption loss. In FIG. 12, a vertical axis is amount of increase in light absorption loss (%), and a horizontal axis is wavelength (nm). It can be seen from FIG. 12 that, at wavelength of 430 nm, absorption loss increases by about 1.5% in Comparative Example 2, whereas absorption loss does not increase in Example 6. Moreover, according to a comparison between Example 3 (FIG. 5) and Comparative Examples 1 and 2 (FIGS. 10 and 11), it can be understood that an antireflective film AR having improved antireflective performance can be achieved even without use of MgF₂.

TABLE 1
EXAMPLE 1 (λ₀ = 550 nm)

| | FILM FORMING | | REFRACTIVE |
|---|---|---|---|
| LAYER | MATERIAL | QWOT | INDEX nd |
| FIRST LAYER | SiO₂ | 0.94 | 1.47 |
| SECOND LAYER | Ta₂O₅ | 1.11 | 2.25 |
| THIRD LAYER | SiO₂ | 0.12 | 1.47 |
| FOURTH LAYER | Ta₂O₅ | 0.53 | 2.25 |
| FIFTH LAYER | SiO₂ | 2.14 | 1.47 |
| SIXTH LAYER | Ta₂O₅ | 0.35 | 2.25 |
| SEVENTH LAYER | SiO₂ | 0.41 | 1.47 |
| EIGHTH LAYER | Ta₂O₅ | 0.27 | 2.25 |

| | |
|---|---|
| OPTICAL ELEMENT SUBSTRATE (νd = 22.76) | 1.81 |

TABLE 2
EXAMPLE 2 (λ₀ = 550 nm)

| | FILM FORMING | | REFRACTIVE |
|---|---|---|---|
| LAYER | MATERIAL | QWOT | INDEX nd |
| FIRST LAYER | SiO₂ | 0.91 | 1.47 |
| SECOND LAYER | TiO₂ | 1.15 | 2.41 |
| THIRD LAYER | SiO₂ | 0.05 | 1.47 |
| FOURTH LAYER | TiO₂ | 0.55 | 2.41 |
| FIFTH LAYER | SiO₂ | 1.96 | 1.47 |
| SIXTH LAYER | TiO₂ | 0.56 | 2.41 |
| SEVENTH LAYER | SiO₂ | 0.16 | 1.47 |
| EIGHTH LAYER | TiO₂ | 1.01 | 2.41 |
| NINTH LAYER | SiO₂ | 0.27 | 1.47 |
| TENTH LAYER | TiO₂ | 0.29 | 2.41 |

| | |
|---|---|
| OPTICAL ELEMENT SUBSTRATE (νd = 41.15) | 1.70 |

TABLE 3
EXAMPLE 3 (λ₀ = 550 nm)

| | FILM FORMING | | REFRACTIVE |
|---|---|---|---|
| LAYER | MATERIAL | QWOT | INDEX nd |
| FIRST LAYER | SiO₂ | 0.91 | 1.47 |
| SECOND LAYER | TiO₂ | 1.35 | 2.41 |
| THIRD LAYER | SiO₂ | 0.05 | 1.47 |
| FOURTH LAYER | TiO₂ | 0.40 | 2.41 |
| FIFTH LAYER | SiO₂ | 1.91 | 1.47 |
| SIXTH LAYER | TiO₂ | 0.49 | 2.41 |
| SEVENTH LAYER | SiO₂ | 0.12 | 1.47 |
| EIGHTH LAYER | TiO₂ | 1.29 | 2.41 |
| NINTH LAYER | SiO₂ | 0.20 | 1.47 |
| TENTH LAYER | TiO₂ | 0.31 | 2.41 |

| | |
|---|---|
| OPTICAL ELEMENT SUBSTRATE (νd = 22.76) | 1.81 |

TABLE 4
EXAMPLE 4 (λ₀ = 550 nm)

| | FILM FORMING | | REFRACTIVE |
|---|---|---|---|
| LAYER | MATERIAL | QWOT | INDEX nd |
| FIRST LAYER | SiO₂ | 0.91 | 1.47 |
| SECOND LAYER | TiO₂ | 1.53 | 2.41 |
| THIRD LAYER | SiO₂ | 0.07 | 1.47 |
| FOURTH LAYER | TiO₂ | 0.26 | 2.41 |
| FIFTH LAYER | SiO₂ | 1.89 | 1.47 |
| SIXTH LAYER | TiO₂ | 0.46 | 2.41 |
| SEVENTH LAYER | SiO₂ | 0.14 | 1.47 |
| EIGHTH LAYER | TiO₂ | 1.30 | 2.41 |
| NINTH LAYER | SiO₂ | 0.16 | 1.47 |
| TENTH LAYER | TiO₂ | 0.33 | 2.41 |

| | |
|---|---|
| OPTICAL ELEMENT SUBSTRATE (νd = 31.32) | 1.90 |

TABLE 5
EXAMPLE 5 (λ₀ = 550 nm)

| | FILM FORMING | | REFRACTIVE |
|---|---|---|---|
| LAYER | MATERIAL | QWOT | INDEX nd |
| FIRST LAYER | SiO₂ | 0.93 | 1.47 |
| SECOND LAYER | Nb₂O₅ | 1.08 | 2.35 |
| THIRD LAYER | SiO₂ | 0.08 | 1.47 |
| FOURTH LAYER | Nb₂O₅ | 0.58 | 2.35 |
| FIFTH LAYER | SiO₂ | 2.01 | 1.47 |
| SIXTH LAYER | Nb₂O₅ | 0.53 | 2.35 |
| SEVENTH LAYER | SiO₂ | 0.21 | 1.47 |
| EIGHTH LAYER | Nb₂O₅ | 0.92 | 2.35 |
| NINTH LAYER | SiO₂ | 0.24 | 1.47 |
| TENTH LAYER | Nb₂O₅ | 0.31 | 2.35 |

| | |
|---|---|
| OPTICAL ELEMENT SUBSTRATE (νd = 22.76) | 1.81 |

TABLE 6
EXAMPLE 6 (λ0 = 550 nm)

| | FILM FORMING | | REFRACTIVE |
|---|---|---|---|
| LAYER | MATERIAL | QWOT | INDEX nd |
| FIRST LAYER | SiO₂ | 0.96 | 1.47 |
| SECOND LAYER | Ta₂O₅ | 1.10 | 2.25 |
| THIRD LAYER | SiO₂ | 0.11 | 1.47 |
| FOURTH LAYER | Ta₂O₅ | 0.58 | 2.25 |
| FIFTH LAYER | SiO₂ | 2.11 | 1.47 |
| SIXTH LAYER | Ta₂O₅ | 0.51 | 2.25 |
| SEVENTH LAYER | SiO₂ | 0.26 | 1.47 |
| EIGHTH LAYER | Ta₂O₅ | 0.88 | 2.25 |
| NINTH LAYER | SiO₂ | 0.25 | 1.47 |
| TENTH LAYER | Ta₂O₅ | 0.33 | 2.25 |

| | |
|---|---|
| OPTICAL ELEMENT SUBSTRATE (νd = 22.76) | 1.81 |

TABLE 7
EXAMPLE 7 (λ₀ = 550 nm)

| | FILM FORMING | | REFRACTIVE |
|---|---|---|---|
| LAYER | MATERIAL | QWOT | INDEX nd |
| FIRST LAYER | SiO₂ | 0.98 | 1.47 |
| SECOND LAYER | Ta₂O₅ | 1.16 | 2.25 |
| THIRD LAYER | SiO₂ | 0.09 | 1.47 |
| FOURTH LAYER | Ta₂O₅ | 0.61 | 2.25 |
| FIFTH LAYER | SiO₂ | 2.06 | 1.47 |
| SIXTH LAYER | Ta₂O₅ | 0.57 | 2.25 |
| SEVENTH LAYER | SiO₂ | 0.10 | 1.47 |
| EIGHTH LAYER | Ta₂O₅ | 1.36 | 2.25 |
| NINTH LAYER | SiO₂ | 0.43 | 1.47 |
| TENTH LAYER | Ta₂O₅ | 0.31 | 2.25 |
| ELEVENTH | SiO₂ | 0.91 | 1.47 |
| LAYER | | | |
| TWELFTH LAYER | Ta₂O₅ | 0.22 | 2.25 |
| THIRTEENTH | SiO₂ | 0.40 | 1.47 |
| LAYER | | | |

| | |
|---|---|
| OPTICAL ELEMENT SUBSTRATE (νd = 22.76) | 1.81 |

TABLE 8
COMPARATIVE EXAMPLE 1 (λ₀ = 550 nm)

| | FILM FORMING | | REFRACTIVE |
|---|---|---|---|
| LAYER | MATERIAL | QWOT | INDEX nd |
| FIRST LAYER | MgF₂ | 0.93 | 1.38 |
| SECOND LAYER | LaTiO₃ | 1.91 | 2.10 |
| THIRD LAYER | Al₂O₃ | 1.53 | 1.62 |
| FOURTH LAYER | MgF₂ | 0.16 | 1.38 |

| | |
|---|---|
| OPTICAL ELEMENT SUBSTRATE (νd = 22.76) | 1.81 |

TABLE 9
COMPARATIVE EXAMPLE 2 (λ₀ = 550 nm)

| | FILM FORMING | | REFRACTIVE |
|---|---|---|---|
| LAYER | MATERIAL | QWOT | INDEX nd |
| FIRST LAYER | MgF₂ | 0.93 | 1.38 |
| SECOND LAYER | LaTiO₃ | 1.86 | 2.06 |
| THIRD LAYER | Al₂O₃ | 2.08 | 1.62 |
| FOURTH LAYER | LaTiO₃ | 0.43 | 2.06 |
| FIFTH LAYER | Al₂O₃ | 0.39 | 1.62 |
| SIXTH LAYER | LaTiO₃ | 0.35 | 2.06 |

| | |
|---|---|
| OPTICAL ELEMENT SUBSTRATE (νd = 22.76) | 1.81 |

Although the disclosure has been described with respect to only a limited number of embodiments, those skilled in the art, having benefit of this disclosure, will appreciate that various other embodiments may be devised without departing from the scope of the present invention. Accordingly, the scope of the invention should be limited only by the attached claims.

### REFERENCE SIGNS LIST

DS optical element
AR antireflective film
SU optical element substrate
Ci i-th layer (i=1, 2, . . . , n)
LN projection lens
LN1 first optical system
LN2 second optical system
Gr1 first lens group
Gr2a second a-lens group
Gr2b second b-lens group
Gr2c second c-lens group
Gr2d second d-lens group
ST aperture stop
IM1 intermediate image (intermediate image surface)
IM2 image display surface (reduction side image surface)
L17 lens element (optical element)
AX optical axis

1. An optical element comprising:
an optical element substrate; and
an antireflective film on the optical element substrate, wherein
the antireflective film has a structure in which, in order from an air side of the antireflective film, a SiO₂ low-refractive index film and one or more TiO₂, Nb₂O₅, or Ta₂O₅ high-refractive index films are alternately stacked in eight or more layers, and
when a predetermined wavelength is 550 nm in the antireflective film, quarter wave optical thicknesses from a first layer to a sixth layer, from the air side of the antireflective film, are as follows:
0.94±0.05 in the first layer;
1.29±0.25 in a second layer;
0.08±0.05 in a third layer;
0.45±0.20 in a fourth layer;
2.05±0.20 in a fifth layer; and
0.45±0.20 in the sixth layer.

2. The optical element according to claim 1, wherein
a total number of film layers of the antireflective film is ten,
when a predetermined wavelength is 550 nm in the antireflective film, quarter wave optical thicknesses from a seventh layer to a tenth layer, from the air side of the antireflective film, are as follows:
0.19±0.10 in the seventh layer;
1.03±0.35 in an eighth layer;
0.24±0.15 in a ninth layer; and
0.30±0.10 in the tenth layer, and
maximum reflectivity in a wavelength range of 420 nm to 680 nm is 0.2% or less.

3. The optical element according to claim 1, wherein
a total number of film layers of the antireflective film is thirteen,
when a predetermined wavelength is 550 nm in the antireflective film, quarter wave optical thicknesses of a seventh layer to a thirteenth layer, from the air side of the antireflective film, are as follows:
0.11±0.10 in the seventh layer;
1.32±0.10 in an eighth layer;
0.42±0.10 in a ninth layer;
0.31±0.10 in a tenth layer;
1.05±0.35 in an eleventh layer;
0.21±0.15 in a twelfth layer; and
0.38±0.10 in the thirteenth layer, and
maximum reflectivity in a wavelength range of 420 nm to 780 nm is 0.4% or less.

4. The optical element according to claim 1, wherein, when the optical element substrate is coated with the antireflective film while being left for one hour or more at 300° C. or higher, a light absorption loss of the optical element increases by 1% or more at a wavelength of 430 nm.

5. The optical element according to claim 1, wherein
a refractive index of the optical element substrate with respect to a D-line of sodium is 1.80809±0.001, and
an Abbe number of the optical element substrate is 22.76±0.36.

6. A projector-grade projection lens comprising:
the optical element according to claim 1 as a lens element.

7. The optical element according to claim 2, wherein, when the optical element substrate is coated with the antireflective film while being left for one hour or more at 300° C. or higher, a light absorption loss of the optical element increases by 1% or more at a wavelength of 430 nm.

8. The optical element according to claim 2, wherein
a refractive index of the optical element substrate with respect to a D-line of sodium is 1.80809±0.001, and
an Abbe number of the optical element substrate is 22.76±0.36.

9. A projector-grade projection lens comprising:
the optical element according to claim 2 as a lens element.

10. The optical element according to claim 3, wherein, when the optical element substrate is coated with the antireflective film while being left for one hour or more at 300° C. or higher, a light absorption loss of the optical element increases by 1% or more at a wavelength of 430 nm.

11. The optical element according to claim 3, wherein
a refractive index of the optical element substrate with respect to a D-line of sodium is 1.80809±0.001, and
an Abbe number of the optical element substrate is 22.76±0.36.

12. A projector-grade projection lens comprising:
the optical element according to claim 3 as a lens element.

13. The optical element according to claim 4, wherein
a refractive index of the optical element substrate with respect to a D-line of sodium is 1.80809±0.001, and
an Abbe number of the optical element substrate is 22.76±0.36.

14. A projector-grade projection lens comprising:
the optical element according to claim 4 as a lens element.

15. A projector-grade projection lens comprising:
the optical element according to claim 5 as a lens element.
